(19) United States
(12) Patent Application Publication
(10) Pub. No.: US 2024/0027138 A1
(43) Pub. Date: Jan. 25, 2024

(54) Chamber Sealing Process for Temperature Equalizing Plate and Temperature Equalizing Plate Manufactured by Same

(71) Applicant: Raytech Precision Technologies (Shuyang) Co., Ltd., Suqian City (CN)

(72) Inventors: Shengliang Dai, Suqian (CN); Zhouzhou Chen, Suqian (CN); Yongli Chen, Suqian (CN)

(21) Appl. No.: 18/342,699

(22) Filed: Jun. 27, 2023

Related U.S. Application Data
(63) Continuation of application No. PCT/CN2022/112151, filed on Aug. 12, 2022.

(30) Foreign Application Priority Data
Jul. 21, 2022 (CN) 202210860310.5

(51) Int. Cl. F28D 15/04; B23P 15/26; B23K 26/21

(52) U.S. Cl. CPC F28D 15/04; B23P 15/26; B23K 26/21; B23P 2700/09

(57) ABSTRACT

The present invention provides a chamber sealing process for a temperature equalizing plate. The chamber sealing process includes steps of providing a bottom cover, a cover plate and a capillary structure with a sunken groove; forming an inner cavity by enclosing the cover plate and the bottom cover; placing the capillary structure between the cover plate and the bottom cover, and then installing the cover plate in the sunken groove; and performing laser welding on a contact area between the cover plate and the bottom cover to seal the inner cavity for obtaining a temperature equalizing plate with a sealed chamber. It can greatly reduce the manufacturing cost and greatly improve the production efficiency.

### FIELD OF THE PRESENT DISCLOSURE

The invention belongs to the technical field of heat conduction technology, and in particular relates to a chamber sealing process for temperature equalizing plate and a temperature equalizing plate.

### DESCRIPTION OF RELATED ART

In the 5G era, electronic products and equipment are showing the development trend of high frequency, high speed, integration, and thinning, which makes the CPU/GPU and other components generate more and more heat when they are in use. In order to efficiently transfer this intensive heat to the environment outside the chassis, in order to maintain the smooth operation of the core electronic element device at the permissible temperature. In order to improve the performance of electronic terminals, more and more products use temperature equalizing plates as heat dissipation components.

The chamber of temperature equalizing plate in the related art is mainly achieved by brazing the edges. However, the helper solder of the brazing solder is not completely volatilized during soldering, and is easily integrated into the chamber, resulting in reduced reliability. At the same time, brazing uses the furnace body process, which requires multiple use of high temperature in the process, which reduces the efficiency and increases the cost.

Therefore, it is necessary to provide a new chamber sealing process for temperature equalizing plate to solve at least one of the above-mentioned defects.

### SUMMARY OF THE PRESENT INVENTION

The purpose of the present invention is to provide a chamber sealing process for temperature equalizing plate and a temperature equalizing plate, which can solve the problem of low sealing reliability of the chamber of temperature equalizing plate in the related art.

The present invention provides a chamber sealing process for a temperature equalizing plate. The chamber sealing process includes steps of providing a bottom cover, a cover plate and a capillary structure with a sunken groove; forming an inner cavity by enclosing the cover plate and the bottom cover; placing the capillary structure between the cover plate and the bottom cover, and then installing the cover plate in the sunken groove; and performing laser welding on a contact area between the cover plate and the bottom cover to seal the inner cavity for obtaining a temperature equalizing plate with a sealed chamber. It can greatly reduce the manufacturing cost and greatly improve the production efficiency.

Further, the bottom cover includes a connection edge extending outwardly from an edge of the sunken groove; the cover plate is attached to one side of the connection edge; and wherein the step of performing laser welding on the contact area between the cover plate and the bottom cover to seal the inner cavity further includes steps of: utilizing tooling with a light through channel to press the connection edge of the cover plate and the bottom cover; irradiating laser on the contact area between the cover plate and the connection edge of the bottom cover along the light through channel of the tooling, and sealing the inner cavity with a weld seam formed on the contact area.

Further, the light through channel is provided between an inner edge of the tooling and an outer edge of the tooling; a predetermined distance is set between the inner edge of the tooling and the side wall of the sunken groove.

Further, the predetermined distance ranges from 0.2 mm to 0.8 mm.

Further, the chamber sealing process includes a step of performing tempering process on the temperature equalizing plate.

Further, the chamber sealing process includes steps of obtaining a cavity body by pumping the sealed chamber through a injection port reserved by the temperature equalizing plate; injecting a working medium into the true cavity through an injection port reserved by the temperature equalizing plate; and sealing the injection port.

Further, the molding method of the capillary structure includes any one of mesh structure, braided copper powder, and sintering.

Further, the sunken groove of the bottom cover is formed by etching or stamping; a protruded point is provided on the side of the cover plate close to the bottom cover, and the protruded point is formed by etching or stamping.

Further, the bottom cover is made of any one of copper, stainless steel, and titanium alloys.

The present invention further provides a temperature equalizing plate, made by a chamber sealing process as described above, wherein the temperature equalizing plate includes: a bottom cover with a sunken groove; a cover plate which covers a groove opening of the sunken groove and which forms a sealed chamber together with the bottom cover; a capillary structure fixed in the sealed chamber; a contact area between the cover plate and the bottom cover is fixed by laser welding; the capillary structure is connected to the cover plate and the bottom cover respectively.

The temperature equalizing plate in this solution uses a laser to realize the welding and sealing of the cover plate and the bottom cover. During the welding process, the cover plate and the bottom cover are directly fused and welded without adding other solders. Therefore, the chamber of the temperature equalizing plate is not polluted, and the sealing reliability of the chamber of temperature equalizing plate is improved. At the same time, due to the concentrated energy of laser welding, the weld seam is small, and the sealing of smaller sealing edges can be achieved. The penetration depth of weld seam is higher than that of brazing, and the welding tension is increased by more than 0.5 times. In this way, the chamber can withstand greater tension and better seal. Moreover, the laser device can move quickly, and the welding shape and welding track can be adjusted in real time. It can greatly reduce the manufacturing cost and greatly improve the production efficiency.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a flow chart of a chamber sealing process for temperature equalizing plate of an embodiment of the present invention;

FIG. 2 is a flow chart of a refinement process of the chamber sealing process;

FIG. 3 illustrates a state of the temperature equalizing plate during welding;

FIG. 4 is a cross-sectional view of the temperature equalizing plate.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

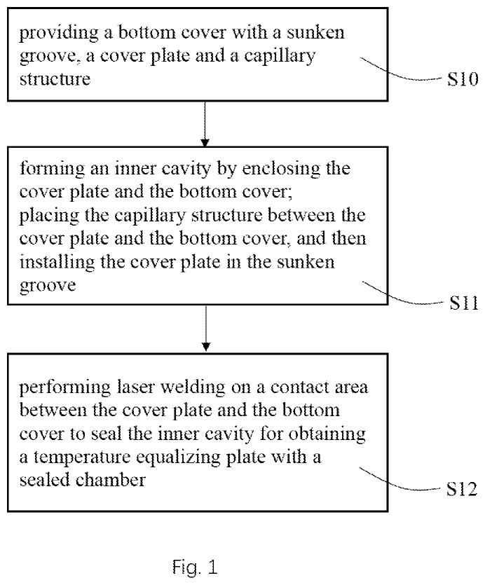

See FIG. 1, a chamber sealing process for temperature equalizing plate that includes the following steps:

Step s10: a bottom cover 1 with sunken groove 11, a cover plate 2 and a capillary structure 3 are provided.

Step s11: the capillary structure 3 is placed between the cover plate 2 and the bottom cover 1, and then the cover plate 2 is installed in the groove opening of the sunken groove 11, and the cover plate 2 and the bottom cover 1 are enclosed to form an inner cavity.

Specifically, the capillary structure 3 can be installed in the sunken groove 11 of the bottom cover 1, or can be installed on the plate surface of the cover plate 2 on the side close to the bottom cover 1. In this way, the capillary structure 3 is located in the inner cavity after the cover plate 2 is capped on the bottom cover 1. The capillary structure 3 is attached tightly to the groove wall of the sunken groove 11 of the bottom cover 1 and the inner surface of the cover plate 2. It should be understood that at this time, the cover plate 2 and the bottom cover 1 are not fixed, and the cover plate 2 and the bottom cover 1 are only attached together.

Step s12: laser welding is performed on the contact area between the cover plate 2 and the edge of the bottom cover 1 to seal the inner cavity to obtain a temperature equalizing plate with a sealed chamber.

Specifically, after laser welding, cover plate 2 and bottom cover 1 are fixed together, and the weld seam 4 formed by laser welding will seal the inner cavity of the combined body, thereby obtaining a temperature equalizing plate with a sealed chamber.

In this embodiment, compared with the temperature equalizing plate in the prior art, which is sealed and fixed by brazing welding, in this solution the temperature equalizing plate adopts laser to realize the welding and sealing of cover plate 2 and the bottom cover 1. During the welding process, the cover plate 2 and the bottom cover 1 are directly fused and welded, no need to add other solders. Therefore, the chamber of the temperature equalizing plate is not polluted, and the sealing reliability of the chamber of temperature equalizing plate is improved. At the same time, because of the concentrated energy of laser welding, the weld seam 4 is small, and the sealing of smaller sealing edges can be achieved. The penetrating depth of weld seam 4 is higher than that of brazing, and the welding tension is increased by more than 0.5 times, so that the chamber can withstand greater tensile force and has better sealing performance. Moreover, the laser device can move quickly, and the welding shape and welding track can be adjusted in real time. It can greatly reduce the manufacturing cost and greatly improve the production efficiency.

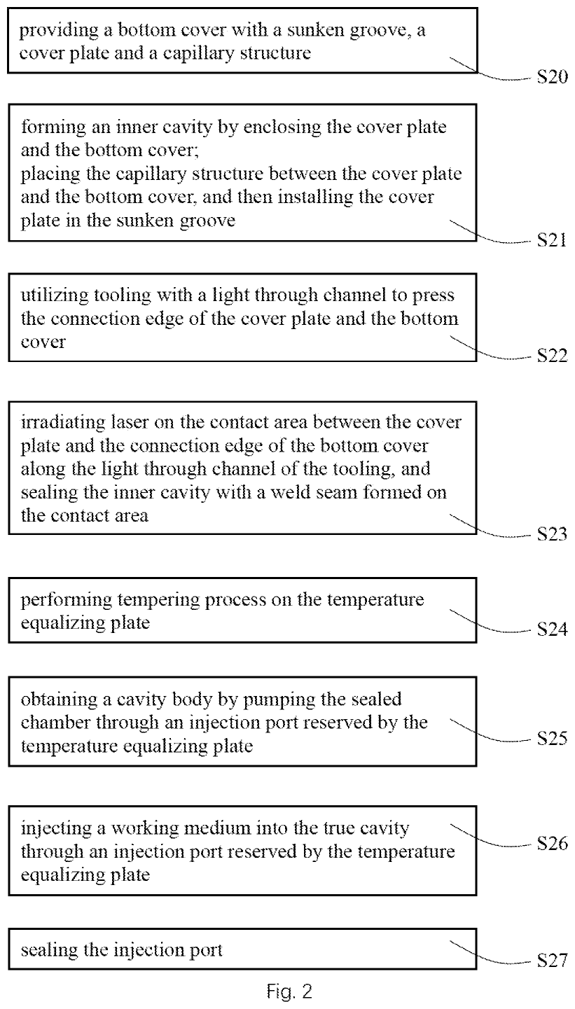

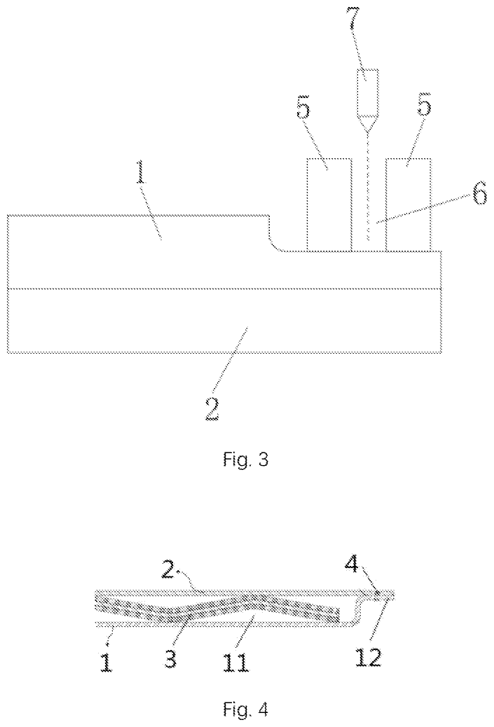

Further, referring to FIGS. 2-3, the embodiment of the present invention also provides a chamber sealing process for temperature equalizing plate, including the following steps:

Step s20: provide a bottom cover 1 with sunken groove 11, a cover plate 2 and a capillary structure 3.

Step s21: place the capillary structure 3 between the cover plate 2 and the bottom cover 1, and then place the cover plate 2 to cover the groove opening of the sunken groove 11. The Cover plate 2 and bottom cover 1 are enclosed to form an inner cavity.

Specifically, the bottom cover 1 includes a connection edge 12 extending outward from the edge of the groove opening of the sunken groove 11. The cover plate 2 is attached to one side of the connection edge 12. And a number of protruded points are fixed on the surface of the cover plate 2 on the side close to the bottom cover 1. The sunken groove 11 of bottom cover 1 is formed by etching or stamping. The protruded point of cover plate 2 is formed by etching or stamping. The molding method of the capillary structure 3 includes any one of mesh structure, braided copper powder, and sintering. The bottom cover 1 includes any one of copper, stainless steel, and titanium alloy.

Step s22: Use tooling with light through channel 6 to press the connection edge 12 of the cover plate 2 and the bottom cover 1 together.

Specifically, the tooling can be a device having a work platform and a pressing mechanism. The pressing structure presses the connection edge 12 of the bottom cover 1 and the cover plate 2 together. The pseudo welding will not occur during subsequent laser welding, which is guaranteed Wherein, the pressing structure may be composed of two pressing blocks 5, and the two pressing blocks 5 are arranged at intervals to form the inner edge and the outer edge of the tooling. The pressing block 5 can press and fix the temperature equalizing plate on the work platform. Moreover, the interval between the two pressing blocks 5 forms a light through channel 6, which ensures that the laser light emitted by the light source 7 can be irradiated on the cover plate 2 or the bottom cover 1 along the light through channel 6. In other embodiments, tooling can also be a device with a work platform and a gripper mechanism. The cover plate 2 and the bottom cover 1 are clamped together by a gripper mechanism. Or the groove opening of the sunken groove 11 of the bottom cover 1 is not connected with the connection edge 12, and the groove opening of the sunken groove 11 is pressed together with the cover plate 2.

Step s23: irradiate the laser is on the contact area between the cover plate 2 and the connection edge 12 of the bottom cover 1 along the light through channel 16 of the tooling to form a weld seam 4 on the contact area to seal the inner cavity, and obtain a temperature equalizing plate with a sealed chamber.

Specifically, the laser light emitted by the light source 7 irradiates the contact area between the cover plate 2 and the edge of the bottom cover 1 from the side of the bottom cover 1 along the light through channel 6 of the tooling, that is, the cover plate 2 is attached to the work platform of the tooling. It is beneficial to stably fix the combined body on the work platform and ensure that the combined body will not shake during laser welding. During laser welding, the laser first heats and melts the contact area between bottom cover 1 and cover plate 2, then the heat is conducted to the contact area between cover plate 2 and bottom cover 1 to heat and melt cover plate 2.

In this way, the contact area between cover plate 2 and the edge of bottom cover 1 forms weld seam 4 to complete the sealing of the chamber. According to actual needs, the laser can be irradiated on the contact area of the edge of the cover plate 2 and the bottom cover 1 along the light through channel 6 of the tooling from the side of the cover plate 2. Or the laser is irradiated on the gap where the bottom cover 1 and the cover plate 2 fit together, so that the bottom cover 1 and the cover plate 2 are welded together.

Further, a light through channel 6 is provided between the outer edge of the tooling and the inner edge of the tooling. A predetermined distance is set between the inner edge of the tooling and the side wall of the sunken groove 11. The range of the predetermined distance is 0.2 mm-0.8 mm, such as 0.2 mm, 0.4 mm, 0.5 mm, 0.7 mm, and 0.8 mm. The deformation of the groove body caused by pressing block 5 directly on the groove body of the bottom cover 1 can be avoided, and a sufficient length can also be reserved to prevent the welding fluid generated by welding from flowing into the sealed chamber. The diameter of the light through channel 6 between the two pressing blocks 5 may be 0.8 mm, 1.0 mm, 1.2 mm, 1.5 mm, 1.8 mm, 2.0 mm, and the like, so that the light through channel 6 can provide enough space for the laser to pass through, and avoid laser damage to the pressing block 5. The pressing block 5 can be 0.8 mm, 1.0 mm, 1.2 mm, 1.5 mm, etc., which ensures that there is sufficient contact area between the bottom cover 1 and the pressing block 5, and ensure that the pressing block 5 can press the bottom cover 1 and the cover plate 2 together.

It should be understood that the area of the contact area between the cover plate 2 and the bottom cover 1 connection edge 12 should not be too large, which will easily reduce the sealing performance of the sealed chamber formed after welding. It should not be too small, as it will increase the difficulty of laser welding.

Step s24: perform tempering process on the temperature equalizing plate.

Specifically, the temperature equalizing plate is put into the furnace body for high temperature tempering to restore the capillary. And the temperature equalizing plate is clamped in the furniture body with a special tool to achieve stress relief and leveling of the material.

Step s25: Evacuate the sealed chamber through the injection port reserved by the temperature equalizing plate to obtain a true cavity body.

Specifically, the injection port is connected with the sealed chamber to ensure that the sealed chamber can be evacuated through the injection port and the working medium can be injected into the sealed chamber.

Step s26: inject the working medium into the true cavity body through the injection port reserved by the temperature equalizing plate.

Specifically, the capillary structure 3 is used to form a working medium for capillary transport, complete the entire power cycle and then complete the thermodynamic cycle.

Step s27: seal the injection port.

Specifically, the injection port can be pressure-sealed and cut off.

In this embodiment, the inner cavity formed by the cover plate 1 and the bottom cover 2 is used to carry the capillary structure 3, the working medium and the steam channel. The sealed chamber of the temperature equalizing plate is in a negative pressure state. It can prevent the loss of the working medium, maintain the vacuum negative pressure state, and play a certain anti-deformation effect. It should be understood that the protruded point of cover plate 1 is used to form a steam channel in the sealed chamber. Since the bottom cover 1 is made of any one of copper, stainless steel, and titanium alloys, the structural strength of the sealed chamber can be improved. Moreover, since the airtightness of the sealed chamber and the cleanliness of the sealed chamber are one of the key conditions for the two-phase flow heat transfer of the product, the laser welding in this embodiment can satisfy both the airtightness of the sealed chamber and the cleanliness of the sealed chamber.

Please refer to FIG. 4, the embodiment of the present invention also provides a temperature equalizing plate, which is made by the above-mentioned chamber sealing process. The temperature equalizing plate includes: a cover plate 2, covering the groove opener of sunken groove 11, forming a cover plate 2 of the sealed chamber together with the bottom cover 1, the capillary structure 3 fixed in the sealed chamber. The contact area between the cover plate 2 and the bottom cover 1 is fixed by the laser welding. The capillary structure 3 is connected to the cover plate 2 and the bottom cover 1 respectively.

Specifically, the sunken groove 11 of the bottom cover 1 is formed by etching or stamping. The cover plate 2 is formed by etching or stamping. The molding method of the capillary structure 3 includes any one of mesh structure, braided copper powder, and sintering. The bottom cover 1 includes any one of copper, stainless steel, and titanium alloy, which can improve the structural strength.

The capillary structure 3 is closely attached to the inner surface of the groove body of the bottom cover 1 and the inner surface of the cover plate 2. During welding, the edges of the cover plate 2 and the bottom cover 1 attach tightly together. The laser is irradiated on the contact area between the cover plate 2 and the edge of the bottom cover 1 from the bottom cover 1 side. The laser first heats and melts the contact area between the bottom cover 1 and the cover plate 2, and then the heat is conducted to the contact area between the cover plate 2 and the bottom cover 1 to heat and melt the cover plate 2. In this way, the contact area between cover plate 2 and the edge of bottom cover 1 forms weld seam 4 to complete the sealing of the chamber.

In this embodiment, compared with the temperature equalizing plate in the prior art, which is sealed and fixed by brazing welding, the temperature equalizing plate in this solution uses a laser to realize the welding and sealing of the cover plate 2 and the bottom cover 1. During the welding process, the cover plate 2 and the bottom cover 1 are directly fused and welded, no need to add other solders. Therefore, the chamber of the temperature equalizing plate is not polluted, and the sealing reliability of the chamber of temperature equalizing plate is improved. At the same time, because of the concentrated energy of laser welding, the weld seam 4 is small, and the sealing of smaller sealing edges can be achieved.

The penetrating depth of weld seam 4 is higher than that of brazing, and the welding tension is increased by more than 0.5 times, so that the chamber can withstand greater tensile force and has better sealing performance. Moreover, the laser device can move quickly, and the welding shape and welding track can be adjusted in real time. It can greatly reduce the manufacturing cost and greatly improve the production efficiency.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A chamber sealing process for a temperature equalizing plate, the chamber sealing process includes:
providing a bottom cover with a sunken groove, a cover plate and a capillary structure;
forming an inner cavity by enclosing the cover plate and the bottom cover;
placing the capillary structure between the cover plate and the bottom cover, and then installing the cover plate in the sunken groove;
performing laser welding on a contact area between the cover plate and the bottom cover to seal the inner cavity for obtaining a temperature equalizing plate with a sealed chamber.

2. The chamber sealing process of the temperature equalizing plate as described in claim 1, wherein the bottom cover includes a connection edge extending outwardly from an edge of the sunken groove; the cover plate is attached to one side of the connection edge; and wherein the step of performing laser welding on the contact area between the cover plate and the bottom cover to seal the inner cavity further includes steps of:
utilizing tooling with a light through channel to press the connection edge of the cover plate and the bottom cover;
irradiating laser on the contact area between the cover plate and the connection edge of the bottom cover along the light through channel of the tooling, and sealing the inner cavity with a weld seam formed on the contact area.

3. The chamber sealing process of the temperature equalizing plate as described in claim 2, wherein the light through channel is provided between an inner edge of the tooling and an outer edge of the tooling; a predetermined distance is set between the inner edge of the tooling and the side wall of the sunken groove.

4. The chamber sealing process of the temperature equalizing plate as described in claim 3, wherein the predetermined distance ranges from 0.2 mm to 0.8 mm.

5. The chamber sealing process of the temperature equalizing plate as described in claim 1, further including a step of:
performing tempering process on the temperature equalizing plate.

6. The chamber sealing process of the temperature equalizing plate as described in claim 1, further including a step of:
obtaining a cavity body by pumping the sealed chamber through an injection port reserved by the temperature equalizing plate;
injecting a working medium into the true cavity through an injection port reserved by the temperature equalizing plate;
sealing the injection port.

7. The chamber sealing process of the temperature equalizing plate as described in claim 1, wherein the molding method of the capillary structure includes any one of mesh structure, braided copper powder, and sintering.

8. The chamber sealing process of the temperature equalizing plate as described in claim 1, wherein the sunken groove of the bottom cover is formed by etching or stamping; a protruded point is provided on the side of the cover plate close to the bottom cover, and the protruded point is formed by etching or stamping.

9. The chamber sealing process of the temperature equalizing plate as described in claim 1, wherein the bottom cover is made of any one of copper, stainless steel, and titanium alloys.

10. A temperature equalizing plate, made by a chamber sealing process as described in claim 1, wherein the temperature equalizing plate includes:
a bottom cover with a sunken groove;
a cover plate which covers a groove opening of the sunken groove and which forms a sealed chamber together with the bottom cover;
a capillary structure fixed in the sealed chamber; a contact area between the cover plate and the bottom cover is fixed by laser welding; the capillary structure is connected to the cover plate and the bottom cover respectively.
